(19) United States
(12) Patent Application Publication
(10) Pub. No.: US 2016/0163268 A1
(43) Pub. Date: Jun. 9, 2016

(54) DISPLAY DEVICES AND METHODS OF DRIVING THE SAME

(71) Applicant: Samsung Display Co., LTD., Yongin-City (KR)

(72) Inventors: Chan-Hyung YOO, Seoul (KR); Dae-Won KIM, Hwaseong-si (KR); Han-Ki PARK, Incheon (KR); Wook-Jae LEE, Seoul (KR); In-Ho HWANG, Seoul (KR)

(21) Appl. No.: 14/743,894

(22) Filed: Jun. 18, 2015

(30) Foreign Application Priority Data
Dec. 3, 2014 (KR) 10-2014-0172152

(51) Int. Cl. G09G 3/34; G09G 3/32; G09G 3/36

(52) U.S. Cl. CPC G09G 3/342; G09G 3/3607; G09G 3/3208; G09G 2320/0233; G09G 2320/0686; G09G 2320/066

(57) ABSTRACT

A display device includes a display panel and a transparent display panel that overlaps the display panel. The display panel displays a whole image according to an input image signal. The transparent display panel displays a partial image when a region having a dynamic range that is greater than a reference range exists in the whole image, where the partial image corresponds to the region having the dynamic range that is greater than the reference range. Thus, the display device can efficiently improve a dynamic range of an image that is provided to a viewer.

### CROSS-REFERENCE TO RELATED APPLICATION(S)

This application claims priority under 35 USC §119 to Korean Patent Application No. 10-2014-0172152, filed on Dec. 3, 2014 in the Korean Intellectual Property Office (KIPO), the contents of which are incorporated herein in its entirety by reference.

### BACKGROUND

1. Technical Field

Example embodiments relate generally to a display device. More particularly, embodiments of the present inventive concept relate to a display device including a display panel and at least one transparent display panel and a method of driving the display device.

2. Description of the Related Art

A display device may convert an input image signal (i.e., a digital signal) into a data voltage (i.e., an analog signal) and provide the data voltage to pixels to display an image. Generally, the image includes a region having a high dynamic range (HDR) (hereinafter, referred to as an HDR region) and a region having a low dynamic range (LDR) (hereinafter, referred to as an LDR region). Thus, a conventional display device displays the image by normalizing the regions having various (or, different) dynamic ranges in a dynamic range suitable to a display performance of the conventional display device (e.g., display backlight normalization). However, since the conventional display device performs normalization for an image including the HDR region and the LDR region by considering (or, focusing on) the HDR region, a grayscale representation of the LDR region may be degraded by the normalization. In addition, since brightness of the image is continuously changed by the normalization, a viewer may recognize brightness changes of the image according to the dynamic ranges provided to the viewer.

### SUMMARY

Some example embodiments provide a display device capable of improving a dynamic range of an image that is provided to a viewer by displaying the image using a display panel and at least one transparent display panel.

Some example embodiments provide a method of driving the display device.

According to example embodiments, a display device may include a display panel configured to display a whole image according to an input image signal and a transparent display panel configured to display a partial image when a region having a dynamic range that is greater than a reference range exists in the whole image, the partial image corresponding to the region having the dynamic range that is greater than the reference range, the transparent display panel overlapping the display panel.

In example embodiments, the display device may further include a controller configured to control the display panel and the transparent display panel.

In example embodiments, the display device may further include a first controller configured to control the display panel and a second controller configured to control the transparent display panel. Here, the first controller and the second controller may interact with each other.

In example embodiments, the whole image may be classified into a low dynamic range (LDR) region and a high dynamic range (HDR) region based on the reference range.

In example embodiments, the LDR region may be implemented by only the whole image and the HDR region may be implemented by a combination of the whole image and the partial image.

In example embodiments, the display panel and the transparent display panel may be liquid crystal display panels or organic light emitting display panels.

According to example embodiments, a display device may include a display panel configured to display a whole image according to an input image signal, a first transparent display panel configured to display a first partial image when a first region having a dynamic range that is greater than a first reference range exists in the whole image, the first partial image corresponding to the first region having the dynamic range that is greater than the first reference range, the first transparent display panel overlapping the display panel, and a second transparent display panel configured to display a second partial image when a second region having a dynamic range that is greater than a second reference range that is set to be greater than the first reference range exists in the whole image, the second partial image corresponding to the second region having the dynamic range that is greater than the second reference range, the second transparent display panel overlapping the display panel.

In example embodiments, the display device may further include a controller configured to control the display panel, the first transparent display panel, and the second transparent display panel.

In example embodiments, the display device may further include a first controller configured to control the display panel, a second controller configured to control the first transparent display panel, and a third controller configured to control the second transparent display panel. Here, the first controller, the second controller, and the third controller may interact with each other.

In example embodiments, the whole image may be classified into a low dynamic range (LDR) region and a first high dynamic range (HDR) region based on the first reference range and may be classified into the first HDR region and a second HDR region based on the second reference range.

In example embodiments, the LDR region may be implemented by only the whole image, the first HDR region may be implemented by a combination of the whole image and the first partial image, and the second HDR region may be implemented by a combination of the whole image, the first partial image, and the second partial image.

In example embodiments, the display panel, the first transparent display panel, and the second transparent display panel may be liquid crystal display panels or organic light emitting display panels.

According to example embodiments, a method of driving a display device may include an operation of displaying a whole image on a display panel according to an input image signal and an operation of displaying a portion of the whole image on at least one transparent display panel, the transparent display panel overlapping the display panel.

In example embodiments, the operation of displaying the portion of the whole image may include an operation of checking whether a region having a dynamic range that is greater than a reference range exists in the whole image and an operation of displaying a partial image corresponding to the region on the transparent display panel when the region exists in the whole image.

In example embodiments, the whole image may be classified into a low dynamic range (LDR) region and a high dynamic range (HDR) region base on the reference range.

In example embodiments, the LDR region may be implemented by only the whole image and the HDR region is implemented by a combination of the whole image and the partial image.

In example embodiments, the operation of displaying the portion of the whole image may include an operation of checking whether a first region having a dynamic range that is greater than a first reference range exists in the whole image and an operation of displaying a first partial image corresponding to the first region on the first transparent display panel when the first region exists in the whole image.

In example embodiments, the operation of displaying the portion of the whole image may further include an operation of checking whether a second region having a dynamic range that is greater than a second reference range that is set to be greater than the first reference range exists in the whole image and an operation of displaying a second partial image corresponding to the second region on the second transparent display panel when the second region exists in the whole image.

In example embodiments, the whole image may be classified into a low dynamic range (LDR) region and a first high dynamic range (HDR) region base on the first reference range and may be classified into the first HDR region and a second HDR region based on the second reference range.

In example embodiments, the LDR region may be implemented by only the whole image, the first HDR region may be implemented by a combination of the whole image and the first partial image, and the second HDR region may be implemented by a combination of the whole image, the first partial image, and the second partial image.

Therefore, a display device according to example embodiments may efficiently improve a dynamic range of an image that is provided to a viewer by displaying a whole image on a display panel according to an input image signal, where a transparent display panel overlaps the display panel, and by displaying a partial image on the transparent display panel when a region having a dynamic range that is greater than a reference range exists in the whole image, where the partial image corresponds to the region having the dynamic range that is greater than the reference range.

In addition, a method of driving a display device according to example embodiments may efficiently improve a dynamic range of an image that is provided to a viewer by the display device.

### BRIEF DESCRIPTION OF THE DRAWINGS

Illustrative, non-limiting example embodiments will be more clearly understood from the following detailed description in conjunction with the accompanying drawings.

FIG. 1 is a block diagram illustrating a display device according to example embodiments.

FIG. 2 is a concept diagram illustrating an example in which an image is provided to a viewer by the display device of FIG. 1.

FIG. 3 is a diagram illustrating an example in which an LDR region and an HDR region are implemented by the display device of FIG. 1.

FIG. 4 is a block diagram illustrating a display device according to example embodiments.

FIG. 5 is a diagram illustrating an example in which an LDR region, a first HDR region, and a second HDR region are implemented by the display device of FIG. 4.

FIG. 6 is a flowchart illustrating a method of driving a display device according to example embodiments.

FIG. 7 is a flowchart illustrating an example in which an LDR region and an HDR region are implemented by the method of FIG. 6.

FIG. 8 is a flowchart illustrating an example in which an LDR region, a first HDR region, and a second HDR region are implemented by the method of FIG. 6.

FIG. 9 is a block diagram illustrating an electronic device according to example embodiments.

FIG. 10A is a diagram illustrating an example in which the electronic device of FIG. 9 is implemented as a television.

FIG. 10B is a diagram illustrating an example in which the electronic device of FIG. 9 is implemented as a smart phone.

### DETAILED DESCRIPTION OF THE EMBODIMENTS

Hereinafter, embodiments of the present inventive concept will be explained in detail with reference to the accompanying drawings.

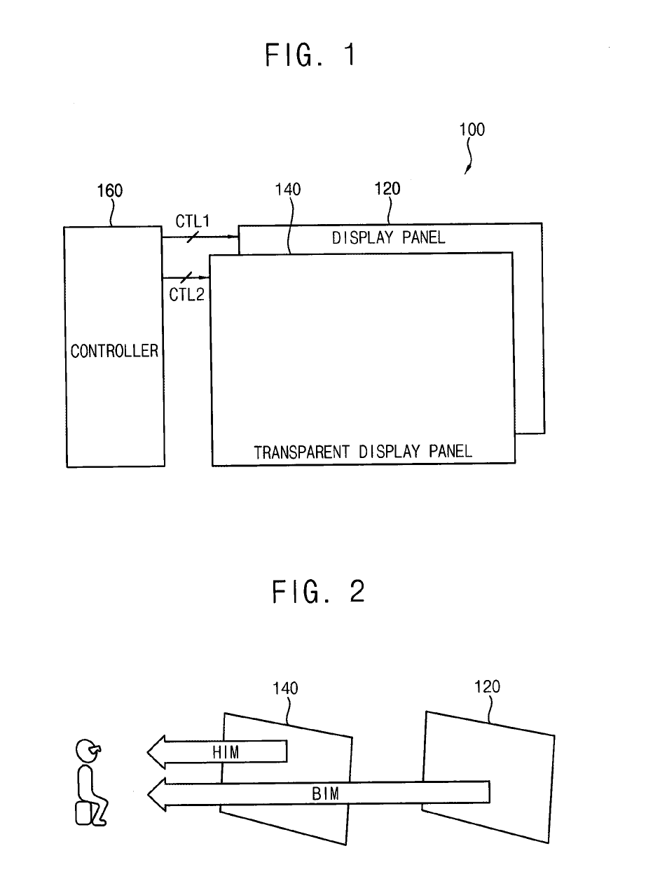

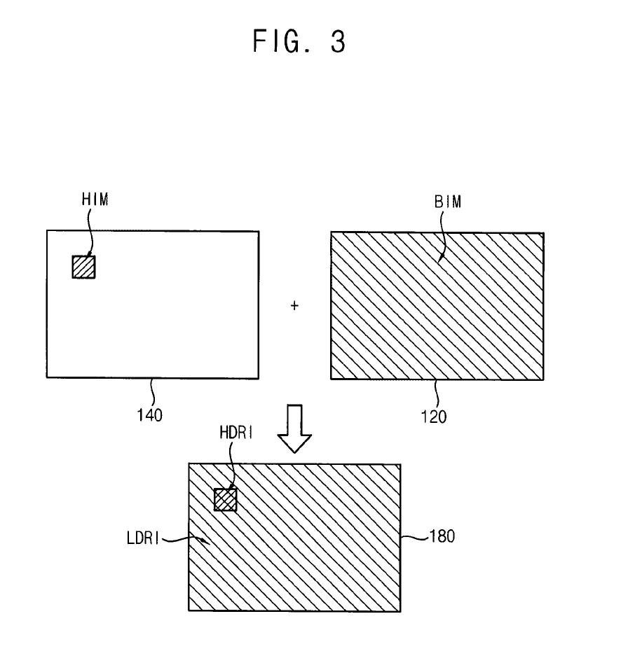

FIG. 1 is a block diagram illustrating a display device according to example embodiments. FIG. 2 is a concept diagram illustrating an example in which an image is provided to a viewer by the display device of FIG. 1. FIG. 3 is a diagram illustrating an example in which an LDR region and an HDR region are implemented by the display device of FIG. 1.

Referring to FIGS. 1 through 3, the display device 100 may include a display panel 120, a transparent display panel 140, and a controller 160. Here, the transparent display panel 140 may overlap the display panel 120. That is, the transparent display panel 140 may be placed over the display panel 120.

The display panel 120 may display a whole image BIM according to an input image signal provided from outside. For this operation, the display panel 120 may include a plurality of pixels. Here, the display panel 120 may be coupled to a scan driver via first through (n)th scan-lines, where n is an integer greater than or equal to 2. In addition, the display panel 120 may be coupled to a data driver via first through (m)th data-lines, where m is an integer greater than or equal to 2. That is, since the pixels of the display panel 120 may be placed at locations corresponding to intersecting points of the first through (n)th scan-lines and the first through (m)th data-lines, the display panel 120 may include n×m pixels. The controller 160 may include the scan driver, the data driver, a timing controller, etc to drive the display panel 120. For example, the scan driver may provide scan signals to the pixels via the first through (n)th scan-lines, and the data driver may provide data signals to the pixels via the first through (m)th data-lines. In addition, the timing controller may control the scan driver and the data driver. In an example embodiment, unlike the transparent display panel 140, the display panel 120 may be a non-transparent display panel. In another example embodiment, like the transparent display panel 140, the display panel 120 may also be a transparent display panel. In some example embodiments, the display panel 120 may be a liquid crystal display panel or an organic light emitting diode display panel. However, the display panel 120 is not limited thereto.

When no image is displayed on the transparent display panel 140, the transparent display panel 140 may be maintained to be transparent. Here, when a region having a dynamic range that is greater than a reference range exists in the whole image BIM displayed on the display panel 120, the transparent display panel 140 may display a partial image HIM corresponding to the region having the dynamic range that is greater that the reference range. On the other hand, when the region having the dynamic range that is greater than the reference range does not exist in the whole image BIM displayed on the display panel 120, the transparent display panel 140 may not display the partial image HIM. That is, the transparent display panel 140 may be maintained to be transparent. The transparent display panel 140 may include a plurality of pixels. Here, the transparent display panel 140 may be coupled to a scan driver via first through (k)th scan-lines, where k is an integer greater than or equal to 2. In addition, the transparent display panel 140 may be coupled to a data driver via first through (j)th data-lines, where j is an integer greater than or equal to 2. That is, since the pixels of the transparent display panel 140 may be placed at locations corresponding to intersecting points of the first through (k)th scan-lines and the first through (j)th data-lines, the transparent display panel 140 may include k×j pixels. The controller 160 may include the scan driver, the data driver, a timing controller, etc to drive the transparent display panel 140. For example, the scan driver may provide scan signals to the pixels via the first through (k)th scan-lines, and the data driver may provide data signals to the pixels via the first through (j)th data-lines. In addition, the timing controller may control the scan driver and the data driver. In some example embodiments, the transparent display panel 140 may be a liquid crystal display panel or an organic light emitting display panel. However, the transparent display panel 140 is not limited thereto.

In an example embodiment, as illustrated in FIG. 1, the display device 100 may include the controller 160 that controls the display panel 120 and the transparent display panel 140 (i.e., indicated as CTL1 and CTL2). Here, the controller 160 may synchronize an operation for displaying the whole image BIM on the display panel 120 with an operation for displaying the partial image HIM on the transparent display panel 140. In addition, the controller 160 may divide an image 180 provided to a viewer into an LDR region LDRI and an HDR region HDRI and may perform an image processing for the LDR region LDRI and the HDR region HDRI. For example, the image processing for the whole image BIM display on the display panel 120 and/or the partial image HIM displayed on the transparent display panel 140 may be performed by software components and/or hardware components. In another example embodiment, the display device 100 may include a first controller that controls the display panel 120 (i.e., indicated as CTL1) and a second controller that controls the transparent display panel 140 (i.e., indicated as CTL2). For example, the first controller may include the scan driver, the data driver, the timing controller, etc to control the display panel 120, and the second controller may include the scan driver, the data driver, the timing controller, etc to control the transparent display panel 140. In this case, the first controller and the second controller interact with each other so that the operation for displaying the whole image BIM on the display panel 120 may be synchronized with the operation for displaying the partial image HIM on the transparent display panel 140. Thus, since the display device 100 additionally displays the HDR region HDRI on the transparent display panel 140 by dividing the image provided to the viewer into the LDR region LDRI and the HDR region HDRI, the display device 100 may display a higher dynamic range image and a brighter image than the conventional display devices. In addition, since the display device 100 does not perform normalization for the image including the HDR region HDRI and the LDR region LDRI, the display device 100 may prevent desaturation of color brightness occurred in a specific region of the image caused by the normalization of image including the HDR region HDRI and the LDR region LDRI.

As illustrated in FIGS. 2 and 3, the whole image BIM displayed on the display panel 120 may be classified into the LDR region LDRI and the HDR region HDRI based on a reference range. Here, an image corresponding to the LDR region LDRI is displayed only on the display panel 120. Thus, the LDR region LDRI may be implemented by only the whole image BIM displayed on the display panel 120. On the other hand, an image corresponding to the HDR region HDRI may be displayed simultaneously on the transparent display panel 140 and the display panel 120. Thus, the HDR region HDRI may be implemented by a combination of the partial image HIM displayed on the transparent display panel 140 and the whole image BIM displayed on the display panel 120. That is, the HDR region HDRI may be implemented by overlapping the partial image HIM displayed on the transparent display panel 140 and the whole image BIM displayed on the display panel 120. In some example embodiments, the display device 100 may further improve a dynamic range of the image 180 that is provided to the viewer by performing an image processing for the whole image BIM displayed on the display panel 120 and the partial image HIM displayed on the transparent display panel 140 (i.e., the HDR region HDRI). In some example embodiments, the display device 100 may further improve a dynamic range of the image 180 that is provided to the viewer by performing an image processing for the whole image BIM displayed on the display panel 120 (i.e., the LDR region LDRI). In brief, the display device 100 may display an image including only the LDR region LDRI on the display panel 120. In this case, the transparent display panel 140 may display no image but maintain transparent state. On the other hand, the display device 100 may display an image including the LDR region LDRI and the HDR region HDRI on the display panel 120 and, at the same time, the transparent display panel 140 may display an image including the HDR region HDRI. Specifically, the display device 100 may display an image corresponding to the LDR region LDRI on the display panel 120, and may display an image corresponding to the HDR region HDRI on the display panel 120 and the transparent display panel 140. For this reason, the display device 100 is not required to perform the normalization for the image including the LDR region LDRI and the HDR region HDRI. As a result, the display device 100 may prevent gray-scale representation degradation of the LDR region LDRI and an unfavorable continuous image brightness change due to the normalization. As described above, the display device 100 may efficiently improve a dynamic range of the image 180 by displaying the whole image BIM on the display panel 120 according to the input image signal and by displaying the partial image HIM on the transparent display panel 140 which overlaps the display panel 120 when a region having a dynamic range that is greater than the reference range exists in the whole image BIM. The partial image HIM corresponds to the region having the dynamic range that is greater than the reference range.

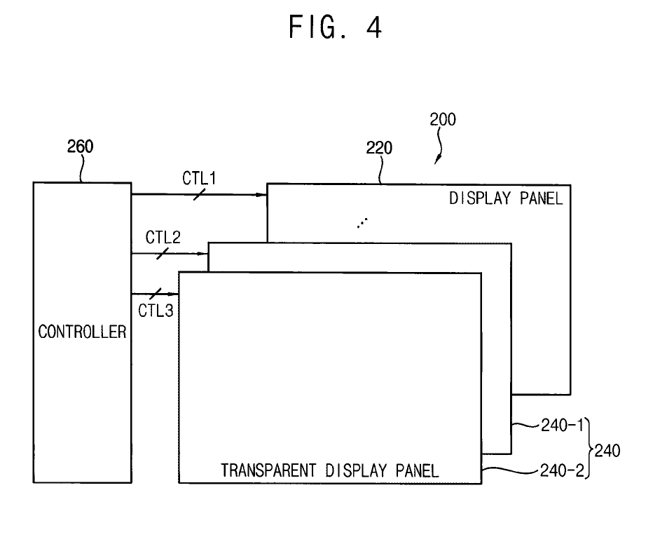

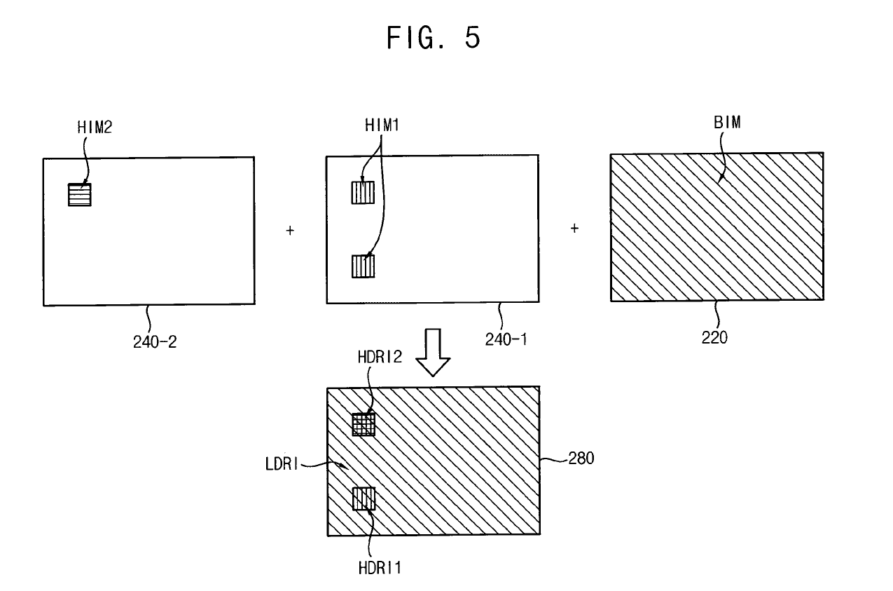

FIG. 4 is a block diagram illustrating a display device according to example embodiments. FIG. 5 is a diagram illustrating an example in which an LDR region, a first HDR region, and a second HDR region are implemented by the display device of FIG. 4.

Referring to FIGS. 4 and 5, the display device 200 may include a display panel 220, a first transparent display panel 240-1, a second transparent display panel 240-2, and a controller 260. Here, the first and second transparent display panels 240-1 and 240-2 may overlap the display panel 220. That is, the first and second transparent display panels 240-1 and 240-2 may be placed over the display panel 220. Although it is illustrated in FIGS. 4 and 5 that the display device 200 includes two transparent display panels 240-1 and 240-2, it should be understood that the display device 200 may include three or more transparent display panels.

The display panel 220 may display a whole image BIM according to an input image signal provided from outside. For this operation, the display panel 220 may include a plurality of pixels. Here, the display panel 220 may be coupled to a scan driver via first through (n)th scan-lines and may be coupled to a data driver via first through (m)th data-lines. That is, since the pixels of the display panel 220 may be placed at locations corresponding to intersecting points of the first through (n)th scan-lines and the first through (m)th data-lines, the display panel 220 may include n×m pixels. The controller 260 may include the scan driver, the data driver, a timing controller, etc to drive the display panel 220. For example, the scan driver may provide scan signals to the pixels via the first through (n)th scan-lines, and the data driver may provide data signals to the pixels via the first through (m)th data-lines. In addition, the timing controller may control the scan driver and the data driver. In an example embodiment, unlike the transparent display panel 240, the display panel 220 may be a non-transparent display panel. In another example embodiment, like the transparent display panel 240, the display panel 220 may also be a transparent display panel. In some example embodiments, the display panel 220 may be a liquid crystal display panel or an organic light emitting display panel. However, the display panel 220 is not limited thereto.

When no image is displayed on the first transparent display panel 240-1, the first transparent display panel 240-1 may be maintained to be transparent. Here, when a first region having a dynamic range that is greater than a first reference range exists in the whole image BIM displayed on the display panel 220, the first transparent display panel 240-1 may display a first partial image HIM1 corresponding to the first region having the dynamic range that is greater than the first reference range. On the other hand, when the first region having the dynamic range that is greater than the first reference range does not exist in the whole image BIM displayed on the display panel 220, the first transparent display panel 240-1 may not display the first partial image HIM1. That is, the first transparent display panel 240-1 may be maintained to be transparent. The first transparent display panel 240-1 may include a plurality of pixels. Here, the first transparent display panel 240-1 may be coupled to a scan driver via first through (k)th scan-lines and may be coupled to a data driver via first through (j)th data-lines. That is, since the pixels of the first transparent display panel 240-1 may be placed at locations corresponding to intersecting points of the first through (k)th scan-lines and the first through (j)th data-lines, the first transparent display panel 240-1 may include k×j pixels. The controller 260 may include the scan driver, the data driver, a timing controller, etc to drive the first transparent display panel 240-1. For example, the scan driver may provide scan signals to the pixels via the first through (k)th scan-lines, and the data driver may provide data signals to the pixels via the first through (j)th data-lines. In addition, the timing controller may control the scan driver and the data driver. In some example embodiments, the first transparent display panel 240-1 may be a liquid crystal display panel or an organic light emitting display panel. However, the first transparent display panel 240-1 is not limited thereto.

When no image is displayed on the second transparent display panel 240-2, the second transparent display panel 240-2 may be maintained to be transparent. Here, when a second region having a dynamic range that is greater than a second reference range exists in the whole image BIM displayed on the display panel 220, the second transparent display panel 240-2 may display a second partial image HIM2 corresponding to the second region having the dynamic range that is greater than the second reference range. The second reference range may be set to be greater than the first reference range. On the other hand, when the second region having the dynamic range that is greater than the second reference range does not exist in the whole image BIM displayed on the display panel 220, the second transparent display panel 240-2 may not display the second partial image HIM2. That is, the second transparent display panel 240-2 may be maintained to be transparent. The second transparent display panel 240-2 may include a plurality of pixels. Here, the second transparent display panel 240-2 may be coupled to a scan driver via first through (q)th scan-lines, where q is an integer greater than or equal to 2. In addition, the second transparent display panel 240-2 may be coupled to a data driver via first through (r)th data-lines, where r is an integer greater than or equal to 2. That is, since the pixels of the second transparent display panel 240-2 may be placed at locations corresponding to intersecting points of the first through (q)th scan-lines and the first through (r)th data-lines, the second transparent display panel 240-2 may include q×r pixels. The controller 260 may include the scan driver, the data driver, a timing controller, etc to drive the second transparent display panel 240-2. For example, the scan driver may provide scan signals to the pixels via the first through (q)th scan-lines, and the data driver may provide data signals to the pixels via the first through (r)th data-lines. In addition, the timing controller may control the scan driver and the data driver. In some example embodiments, the second transparent display panel 240-2 may be a liquid crystal display panel or an organic light emitting display panel. However, the second transparent display panel 240-2 is not limited thereto.

In an example embodiment, as illustrated in FIG. 4, the display device 200 may include the controller 260 that controls the display panel 220, the first transparent display panel 240-1, and the second transparent display panel 240-2 (i.e., indicated as CTL1, CTL2, and CTL3). Here, the controller 260 may synchronize an operation for displaying the whole image BIM on the display panel 220, an operation for displaying the first partial image HIM1 on the first transparent display panel 240-1, and an operation for displaying the second partial image HIM2 on the second transparent display panel 240-2 with each other. In addition, the controller 260 may divide an image 280 provided to a viewer into an LDR region LDRI, a first HDR region HDRI1, and a second HDR region HDRI2 and may perform an image processing for the LDR region LDRI, the first HDR region HDRI1, and the second HDR region HDRI2. For example, the image processing for the whole image BIM display on the display panel 220, the first partial image HIM1 displayed on the first transparent display panel 240-1, and/or the second partial image HIM2 displayed on the second transparent display panel 240-2 may be performed by software components and/or hardware components. In another example embodiment, the display device 200 may include a first controller that controls the display panel 220 (i.e., indicated as CTL1), a second controller that controls the first transparent display panel 240-1 (i.e., indicated as CTL2), and a third controller that controls the second transparent display panel 240-2 (i.e., indicated as CTL3). For example, the first controller may include the scan driver, the data driver, the timing controller, etc to control the display panel 220, the second controller may include the scan driver, the data driver, the timing controller, etc to control the first transparent display panel 240-1, and the third controller may include the scan driver, the data driver, the timing controller, etc to control the second transparent display panel 240-2. In this case, the first controller, the second controller, and the third controller interact with each other so that the operation for displaying the whole image BIM on the display panel 220, the operation for displaying the first partial image HIM1 on the first transparent display panel 240-1, and the operation for displaying the second partial image HIM2 on the second transparent display panel 240-2 may be synchronized with each other. Thus, since the display device 200 additionally displays the HDR regions HDRI1 and HDRI2 on the transparent display panels 240-1 and 240-2 by dividing the image provided to the viewer into the LDR region LDRI and the HDR regions HDRI1 and HDRI2, the display device 200 may display a higher dynamic range image and a brighter image than the conventional display devices. In addition, since the display device 200 does not perform normalization for the image including the LDR region LDRI and the HDR regions HDRI1 and HDRI2, the display device 200 may prevent desaturation of color brightness occurred in a specific region of the image caused by the normalization of image including the HDR regions HDRI1 and HDRI2 and the LDR region LDRI.

As illustrated in FIG. 5, the whole image BIM displayed on the display panel 220 may be classified into the LDR region LDRI and the first HDR region HDRI1 based on a first reference range and may be classified into the first HDR region HDRI1 and the second HDR region HDRI2 based on a second reference range. Here, an image corresponding to the LDR region LDRI is displayed only on the display panel 220. Thus, the LDR region LDRI may be implemented by only the whole image BIM displayed on the display panel 220. On the other hand, an image corresponding to the first HDR region HDRI1 may be simultaneously displayed on the first transparent display panel 240-1 and the display panel 220. Thus, the first HDR region HDRI1 may be implemented by a combination of the first partial image HIM1 displayed on the first transparent display panel 240-1 and the whole image BIM displayed on the display panel 220. That is, the first HDR region HDRI1 may be implemented by overlapping the first partial image HIM1 displayed on the first transparent display panel 240-1 and the whole image BIM displayed on the display panel 220. In addition, an image corresponding to the second HDR region HDRI2 may be simultaneously displayed on the first transparent display panel 240-1, the second transparent display panel 240-2, and the display panel 220. Thus, the second HDR region HDRI2 may be implemented by a combination of the first partial image HIM1 displayed on the first transparent display panel 240-1, the second partial image HIM2 displayed on the second transparent display panel 240-2, and the whole image BIM displayed on the display panel 220. That is, the second HDR region HDRI2 may be implemented by overlapping the first partial image HIM1 displayed on the first transparent display panel 240-1, the second partial image HIM2 displayed on the second transparent display panel 240-2, and the whole image BIM displayed on the display panel 220. In some example embodiments, the display device 200 may further improve a dynamic range of the image 280 that is provided to the viewer by performing an image processing for the whole image BIM displayed on the display panel 220 and the first partial image HIM1 displayed on the first transparent display panel 240-1 (i.e., the first HDR region HDRI1). In some example embodiments, the display device 200 may further improve a dynamic range of the image 280 that is provided to the viewer by performing an image processing for the whole image BIM displayed on the display panel 220, the first partial image HIM1 displayed on the first transparent display panel 240-1, and the second partial image HIM2 displayed on the second transparent display panel 240-2 (i.e., the second HDR region HDRI2). In some example embodiments, the display device 200 may further improve a dynamic range of the image 280 that is provided to the viewer by performing an image processing for the whole image BIM displayed on the display panel 220 (i.e., the LDR region LDRI).

In brief, the display device 200 may display an image including only the LDR region LDRI on the display panel 220. In this case, the transparent display panels 240-1 and 240-2 may display no image. On the other hand, the display device 200 may display an image including the LDR region LDRI and the first HDR region HDRI1 on the display panel 220 and the first transparent display panel 240-1. In addition, the display device 200 may display an image including the LDR region LDRI, the first HDR region HDRI1, and the second HDR region HDRI2 on the display panel 220, the first transparent display panel 240-1, and the second transparent display panel 240-2. Specifically, the display device 200 may display an image corresponding to the LDR region LDRI on the display panel 220, may display an image corresponding to the first HDR region HDRI1 on the display panel 220 and the first transparent display panel 240-1, and may display an image corresponding to the second HDR region HDRI2 on the display panel 220, the first transparent display panel 240-1, and the second transparent display panel 240-2. For this reason, the display device 200 is not required to perform the normalization for the image including the LDR region LDRI and the HDR regions HDRI1 and HDRI2. As a result, the display device 200 may prevent gray-scale representation degradation of the LDR region LDRI and an unfavorable continuous image brightness change due to the normalization. As described above, the display device 200, which overlaps the first and the second transparent display panels 240-1 and 240-2, may efficiently improve a dynamic range of the image 280 by displaying the whole image BIM on the display panel 220 according to the input image signal, by displaying the first partial image HIM1 on the first transparent display panel 240-1 when a first region having a dynamic range that is greater than the first reference range exists in the whole image BIM, where the first partial image HIM1 corresponds to the first region having the dynamic range that is greater than the first reference range, and by displaying the second partial image HIM2 on the second transparent display panel 240-2 when a second region having a dynamic range that is greater than the second reference range exists in the whole image BIM, where the second partial image HIM2 corresponds to the second region having the dynamic range that is greater than the second reference range.

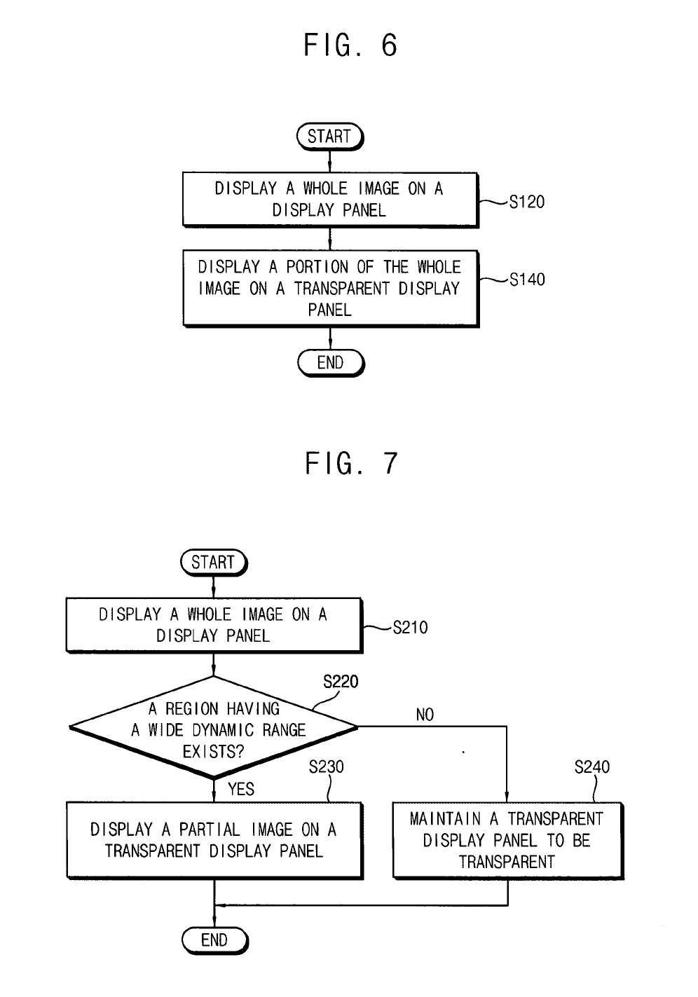

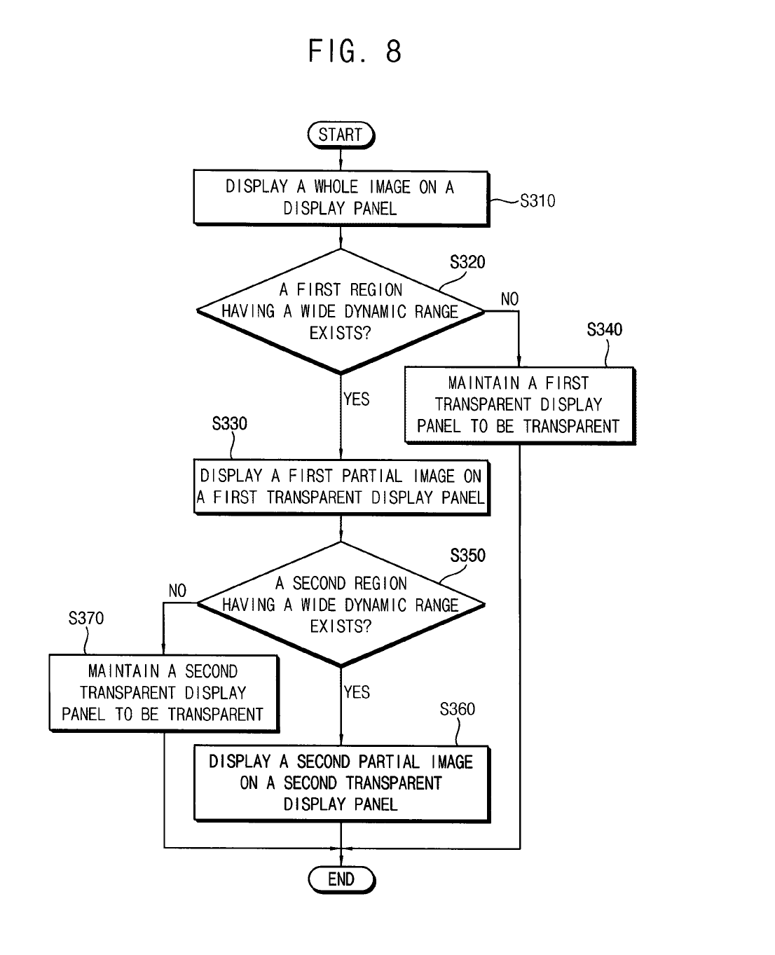

FIG. 6 is a flowchart illustrating a method of driving a display device according to example embodiments. FIG. 7 is a flowchart illustrating an example in which an LDR region and an HDR region are implemented by the method of FIG. 6. FIG. 8 is a flowchart illustrating an example in which an LDR region, a first HDR region, and a second HDR region are implemented by the method of FIG. 6.

Referring to FIGS. 6 through 8, the method of FIG. 6 may display a whole image on a display panel according to an input image signal (S120) and may display a portion of the whole image on at least one transparent display panel that overlaps the display panel (S140). Thus, the method of FIG. 6 may improve a dynamic range of an image that is provided to a viewer by driving the display device that includes the display panel and the transparent display panel.

In an example embodiment, as illustrated in FIG. 7, the method of FIG. 6 may display the whole image on the display panel according to the input image signal (S120) and may display the portion of the whole image on the transparent display panel (S140). Specifically, the method of FIG. 6 may display the whole image on the display panel according to the input image signal (S210) and may check whether a region having a dynamic range that is greater than a reference range exists in the whole image (S220). Here, when the region having the dynamic range that is greater than the reference range exists in the whole image, the method of FIG. 6 may display a partial image corresponding to the region having the dynamic range that is greater than the reference range on the transparent display panel (S230). On the other hand, when the region having the dynamic range that is greater than the reference range does not exist in the whole image, the method of FIG. 6 may maintain the transparent display panel to be transparent (S240). That is, the whole image displayed on the display panel may be classified into the LDR region and the HDR region based on the reference range, the LDR region may be implemented by only the whole image displayed on the display panel, and the HDR region may be implemented by a combination of the whole image displayed on the display panel and the partial image displayed on the transparent display panel. As described above, the method of FIG. 6 may efficiently improve a dynamic range of the image that is provided to the viewer by driving the display device including the display panel and the transparent display panel to display the whole image on the display panel and to display the partial image on the transparent display panel when the region having the dynamic range that is greater than the reference range exists in the whole image.

In another example embodiment, as illustrated in FIG. 8, the method of FIG. 6 may display the whole image on the display panel according to the input image signal (S120) and may display the portion of the whole image on the transparent display panel (S140). Specifically, the method of FIG. 6 may display the whole image on the display panel according to the input image signal (S310) and may check whether a first region having a dynamic range that is greater than a first reference range exists in the whole image (S320). Here, when the first region having the dynamic range that is greater than the first reference range exists in the whole image, the method of FIG. 6 may display a first partial image corresponding to the first region having the dynamic range that is greater than the first reference range on the first transparent display panel (S330). On the other hand, when the first region having the dynamic range that is greater than the first reference range does not exist in the whole image, the method of FIG. 6 may maintain the first transparent display panel to be transparent (S340). Subsequently, the method of FIG. 6 may check whether a second region having a dynamic range that is greater than a second reference range exists in the whole image (S350). Here, when the second region having the dynamic range that is greater than the second reference range exists in the whole image, the method of FIG. 6 may display a second partial image corresponding to the second region having the dynamic range that is greater than the second reference range on the second transparent display panel (S360). On the other hand, when the second region having the dynamic range that is greater than the second reference range does not exist in the whole image, the method of FIG. 6 may maintain the second transparent display panel to be transparent (S370).

That is, the whole image displayed on the display panel may be classified into the LDR region and the first HDR region based on the first reference range and the second HDR region based on the second reference range. Thus, the LDR region may be implemented by only the whole image displayed on the display panel, the first HDR region may be implemented by a combination of the whole image displayed on the display panel and the first partial image displayed on the first transparent display panel, and the second HDR region may be implemented by a combination of the whole image displayed on the display panel, the first partial image displayed on the first transparent display panel, and the second partial image displayed on the second transparent display panel. As described above, the method of FIG. 6 may efficiently improve a dynamic range of the image that is provided to the viewer by driving the display device including the display panel, the first transparent display panel, and the second transparent display panel to display the whole image on the display panel, to display the first partial image on the first transparent display panel when the first region having the dynamic range that is greater than the first reference range exists in the whole image, and to display the second partial image on the second transparent display panel when the second region having the dynamic range that is greater than the second reference range exists in the whole image. In an example embodiment, the display panel overlapping the transparent display panel may be a non-transparent display panel. In another example embodiment, the display panel overlapping the transparent display panel may be a transparent display panel. In addition, the display panel and the transparent display panel may be liquid crystal display panels or organic light emitting display panels. However, the display panel and the transparent display panel are not limited thereto.

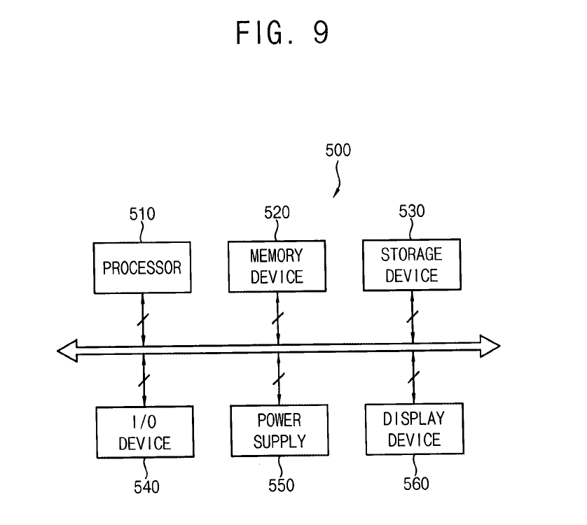

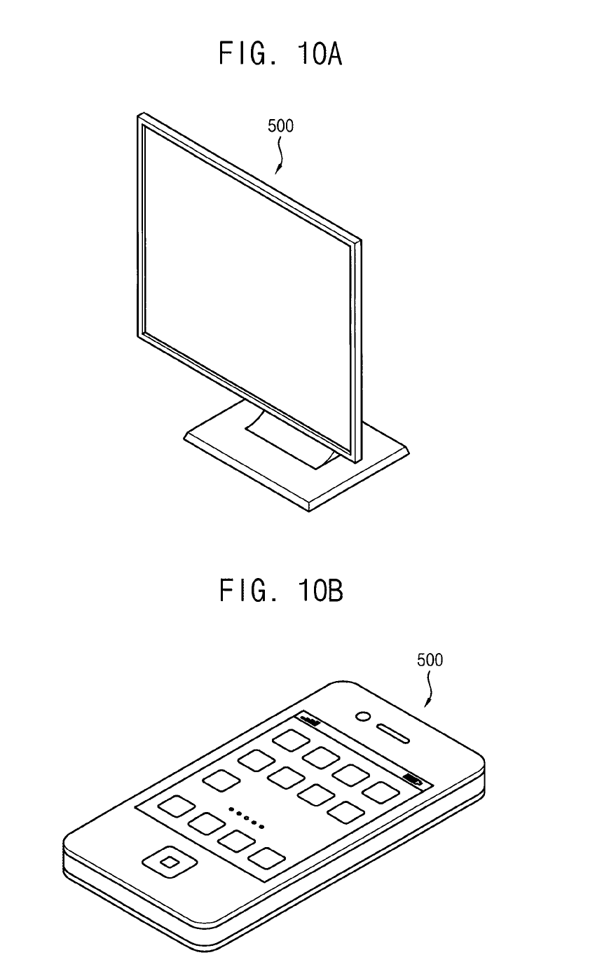

FIG. 9 is a block diagram illustrating an electronic device according to example embodiments. FIG. 10A is a diagram illustrating an example in which the electronic device of FIG. 9 is implemented as a television. FIG. 10B is a diagram illustrating an example in which the electronic device of FIG. 9 is implemented as a smart phone.

Referring to FIGS. 9 through 10B, the electronic device 500 may include a processor 510, a memory device 520, a storage device 530, an input/output (I/O) device 540, a power supply 550, and a display device 560. Here, the display device 560 may correspond to the display device 100 of FIG. 1 or the display device 200 of FIG. 4. In addition, the electronic device 500 may further include a plurality of ports for communicating a video card, a sound card, a memory card, a universal serial bus (USB) device, other electronic devices, etc. In an example embodiment, as illustrated in FIG. 10A, the electronic device 500 may be implemented as a television. In another example embodiment, as illustrated in FIG. 10B, the electronic device 500 may be implemented as a smart phone. However, the electronic device 500 is not limited thereto. For example, the electronic device 500 may be implemented as a computer monitor, a laptop, a digital camera, a cellular phone, a smart pad, a tablet PC, a navigation system, a video phone, etc.

The processor 510 may perform various computing functions. The processor 510 may be a micro processor, a central processing unit (CPU), an application processor (AP), etc. The processor 510 may be coupled to other components via an address bus, a control bus, a data bus, etc. Further, the processor 510 may be coupled to an extended bus such as a peripheral component interconnection (PCI) bus. The memory device 520 may store data for operations of the electronic device 500. For example, the memory device 520 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 530 may be a solid state drive (SSD) device, a hard disk drive (HDD) device, a CD-ROM device, etc.

The I/O device 540 may be an input device such as a keyboard, a keypad, a mouse device, a touchpad, a touch-screen, a remote controller, etc, and an output device such as a printer, a speaker, etc. In some example embodiments, the display device 560 may be included in the I/O device 540. The power supply 550 may provide power for operations of the electronic device 500. The display device 560 may be coupled to other components via the buses or other communication links. As described above, the display device 560 may efficiently improve a dynamic range of an image that is provided to a viewer by displaying a whole image on a display panel according to an input image signal, where a transparent display panel overlaps the display panel, and by displaying a partial image on the transparent display panel when a region having a dynamic range that is greater than a reference range exists in the whole image, where the partial image corresponds to the region having the dynamic range that is greater than the reference range. In an example embodiment, the display device 560 may include a display panel and a transparent display panel. Here, the transparent display panel may overlap the display panel. That is, the transparent display panel may be placed over the display panel. The display panel may display the whole image according to the input image signal. The transparent display panel may display a partial image when a region having a dynamic range that is greater than a reference range exists in the whole image, where the partial image corresponds to the region having the dynamic range that is greater than the reference range. In another example embodiment, the display device 560 may include a display panel, a first transparent display panel, and a second transparent display panel. Here, the first and second transparent display panels may overlap the display panel. That is, the first and second transparent display panels may be placed over the display panel. The display panel may display the whole image according to the input image signal. The first transparent display panel may display a first partial image when a first region having a dynamic range that is greater than a first reference range exists in the whole image, where the first partial image corresponds to the first region having the dynamic range that is greater than the first reference range. The second transparent display panel may display a second partial image when a second region having a dynamic range that is greater than a second reference range that is set to be greater than the first reference range exists in the whole image, where the second partial image corresponds to the second region having the dynamic range that is greater than the second reference range. In an example embodiment, the display panel may be a non-transparent display panel. In another example embodiment, the display panel may be a transparent display panel. Since the display device 560 is described above, duplicated description will not be repeated.

The present inventive concept may be applied to a display device and an electronic device including the display device. For example, the present inventive concept may be applied to a television, a computer monitor, a head mounted display (HMD), a laptop, a digital camera, a cellular phone, a smart phone, a smart pad, a tablet PC, a car navigation system, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device comprising:
a display panel configured to display a whole image according to an input image signal; and
a transparent display panel configured to display a partial image when a region having a dynamic range that is greater than a reference range exists in the whole image, the partial image corresponding to the region having the dynamic range that is greater than the reference range, the transparent display panel overlapping the display panel.

2. The display device of claim 1, further comprising:
a controller configured to control the display panel and the transparent display panel.

3. The display device of claim 1, further comprising:
a first controller configured to control the display panel; and
a second controller configured to control the transparent display panel,
wherein the first controller and the second controller interact with each other.

4. The display device of claim 1, wherein the whole image is classified into a low dynamic range (LDR) region and a high dynamic range (HDR) region based on the reference range.

5. The display device of claim 4, wherein the LDR region is implemented by only the whole image and the HDR region is implemented by a combination of the whole image and the partial image.

6. The display device of claim 1, wherein the display panel and the transparent display panel are liquid crystal display panels or organic light emitting display panels.

7. A display device comprising:
a display panel configured to display a whole image according to an input image signal;
a first transparent display panel configured to display a first partial image when a first region having a dynamic range that is greater than a first reference range exists in the whole image, the first partial image corresponding to the first region having the dynamic range that is greater than the first reference range, the first transparent display panel overlapping the display panel; and
a second transparent display panel configured to display a second partial image when a second region having a dynamic range that is greater than a second reference range that is set to be greater than the first reference range exists in the whole image, the second partial image corresponding to the second region having the dynamic range that is greater than the second reference range, the second transparent display panel overlapping the display panel.

8. The display device of claim 7, further comprising:
a controller configured to control the display panel, the first transparent display panel, and the second transparent display panel.

9. The display device of claim 7, further comprising:
a first controller configured to control the display panel;
a second controller configured to control the first transparent display panel; and
a third controller configured to control the second transparent display panel,
wherein the first controller, the second controller, and the third controller interact with each other.

10. The display device of claim 7, wherein the whole image is classified into a low dynamic range (LDR) region and a first high dynamic range (HDR) region based on the first reference range and is classified into the first HDR region and a second HDR region based on the second reference range.

11. The display device of claim 10, wherein the LDR region is implemented by only the whole image, the first HDR region is implemented by a combination of the whole image and the first partial image, and the second HDR region is implemented by a combination of the whole image, the first partial image, and the second partial image.

12. The display device of claim 11, wherein the display panel, the first transparent display panel, and the second transparent display panel are liquid crystal display panels or organic light emitting display panels.

13. A method of driving a display device, the method comprising:
displaying a whole image on a display panel according to an input image signal; and
displaying a portion of the whole image on at least one transparent display panel, the transparent display panel overlapping the display panel.

14. The method of claim 13, wherein displaying the portion of the whole image includes:
checking whether a region having a dynamic range that is greater than a reference range exists in the whole image; and
displaying a partial image corresponding to the region on the transparent display panel when the region exists in the whole image.

15. The method of claim 14, wherein the whole image is classified into a low dynamic range (LDR) region and a high dynamic range (HDR) region based on the reference range.

16. The method of claim 15, wherein the LDR region is implemented by only the whole image and the HDR region is implemented by a combination of the whole image and the partial image.

17. The method of claim 13, wherein displaying the portion of the whole image includes:
checking whether a first region having a dynamic range that is greater than a first reference range exists in the whole image; and
displaying a first partial image corresponding to the first region on the first transparent display panel when the first region exists in the whole image.

18. The method of claim 17, wherein displaying the portion of the whole image further includes:
checking whether a second region having a dynamic range that is greater than a second reference range that is set to be greater than the first reference range exists in the whole image; and
displaying a second partial image corresponding to the second region on the second transparent display panel when the second region exists in the whole image.

19. The method of claim 18, wherein the whole image is classified into a low dynamic range (LDR) region and a first high dynamic range (HDR) region based on the first reference range and is classified into the first HDR region and a second HDR region based on the second reference range.

20. The method of claim 19, wherein the LDR region is implemented by only the whole image, the first HDR region is implemented by a combination of the whole image and the first partial image, and the second HDR region is implemented by a combination of the whole image, the first partial image, and the second partial image.
